(19) United States
(12) Patent Application Publication
(10) Pub. No.: US 2008/0031706 A1
(43) Pub. Date: Feb. 7, 2008

(54) Method and apparatus for producing printed products composed of a book block and a cover

(75) Inventor: Gunther Silberbauer, Uerkheim (CH)

Correspondence Address: VENABLE LLP, P.O. BOX 34385, WASHINGTON, DC, 20043-9998, US

(73) Assignee: Muller Martini Holding AG, Hergiswil (CH)

(21) Appl. No.: 11/827,000

(22) Filed: Jul. 19, 2007

(30) Foreign Application Priority Data
Jul. 19, 2006 (EP) 06405313.5

(51) Int. Cl. B42C 11/04; B42C 11/00; B42C 99/00

(52) U.S. Cl. 412/19; 412/14; 412/4

(57) ABSTRACT

An apparatus for producing printed products includes a processing device in which respectively one cover is attached to a spine of a book block. A first feed-in station supplies book blocks to the processing device. A second feed-in station supplies the covers to the processing station. A storage unit has a plurality of compartments to accommodate respectively one cover. An intake conveyor is arranged upstream of the storage unit to feed one cover from the second feed-in station to respectively one compartment of the storage device. A discharge conveyor is arranged downstream of the storage unit to convey the covers from the storage unit to the processing device.

### CROSS-REFERENCE TO RELATED APPLICATION

This application claims the priority of European Patent Application No: 06405313.5, filed on Jul. 19, 2006, the subject matter of which is incorporated herein by reference.

### BACKGROUND

The invention relates to a method for producing printed products, composed of a book block and a cover, with the aid of a processing device to which the book blocks and the covers are supplied individually along separate paths and in which respectively one cover is attached along the spine to one book.

A method and an apparatus of the aforementioned type are already known from European Patent Application 1 199 187 A. The processing device disclosed therein is a perfect binder embodied as a revolving table on which the book blocks are processed, for example by milling, trimming or gluing. The book blocks to be processed and provided with a cover are supplied to a feed-in station that preferably comprises a buffer section for the temporary storage of book blocks if the perfect binder is not ready. In the process, the delivery sequence for the book blocks is changed.

The individual covers are supplied at a different station. During the production, it is standard practice to remove a book block for inspection from the conveying section that moves in the direction of the perfect binder and to return this book block later on to the conveying section. As a result of this action as well as the change in sequence in the buffer section, the covers cannot be supplied in the precise sequence that is required. Extremely small editions as well as single-copy editions of books must furthermore be printed at times, wherein this can be realized without problem per se when using digital printers which permit a sequential production of printed sheets. Different types of covers, which can also have different formats, can thus be produced one after another.

### SUMMARY

It is an object of the present invention to provide a method and an apparatus of the aforementioned type, which makes it possible to avoid the previously explained difficulties. It is a further object of the present invention to provide a method and the apparatus that make possible a highly efficient and cost-effective production of small editions and even single-copy editions.

The above and other objects are accomplished according to the invention wherein there is provided a method for producing printed products, which in one embodiment includes: supplying book blocks and covers along respectively separate conveying paths to a processing device; feeding the covers with a controlled movement to a specific compartment of a storage unit having a plurality of compartments arranged along the conveying path of the covers to the processing device, wherein each compartment is supplied with only one cover; and combining respectively one book block and a spine of one cover in the processing device.

According to another aspect of the invention there is provided an apparatus for producing printed products, which in one embodiment includes: a processing device in which respectively one cover is attached to a spine of a book block; a first feed-in station from which the book blocks are supplied to the processing device; a second feed-in station from which the covers are supplied to the processing station; a storage unit having a plurality of compartments to accommodate respectively one cover; an intake conveyor arranged upstream of the storage unit to feed one cover from the second feed-in station to respectively one compartment of the storage device; and a discharge conveyor arranged downstream of the storage unit to convey the covers from the storage unit to the processing device.

In a further embodiment, a control unit provides a separate book block with the associated cover, even if the sequence of the book blocks is changed upstream of the processing device. As a result, an automatic and extremely efficient production is possible even when printing very small editions and single-copy editions. For inspection, the book blocks can be removed at any time from a buffer section and can be returned to it later on. Since the book blocks and thus also the respective covers are identified and supplied with a controlled movement to the processing device, it is ensured that each book block is provided with its respective cover. Different methods can be used to identify the covers and book blocks, even virtual methods. An advantage of the invention is that it can be realized comparatively easily from a control-technical point of view.

According to another embodiment of the invention, the storage unit is provided with several compartments to which the covers are assigned individually and precisely positioned. The control unit as a result always has the information of which cover is located in which storage compartment, thus making possible a very efficient administering of the storage unit compartments when using an intelligent control. The control unit can furthermore select the point in time for removing a cover, to which no book block has been assigned, or for re-supplying this cover later on. Thus, if a book block is detected at the intake of the processing device during a production run, the control unit requests the associated cover from the storage unit. This cover is subsequently supplied to the processing device, thereby ensuring that the book block is combined with the matching cover during the binding process.

An easy and secure identification of the covers is ensured according to a further embodiment of the invention if the covers are respectively provided with an identifying characteristic, such as a barcode or a transponder. Different suitable identification characteristics can also be provided in place of a barcode, which may not be visible to the naked eye and can be detected, for example, with UV radiation.

The printing of a book block inside the printer can be triggered by an identification characteristic that is affixed to a cover.

According to a different embodiment of the invention, the compartments can be moved between an intake conveyor and a discharge conveyor. For this, the compartments can be designed to pivot and/or rotate around a shaft, thereby permitting an extremely efficient use of the storage unit and the easy and quick refilling of an empty compartment.

According to yet another embodiment of the invention, the compartments are designed to rotate around a single shaft. The storage unit is preferably embodied as a fan wheel, which results in an extremely compact and space-saving storage unit and/or arrangement of the compartments.

### BRIEF DESCRIPTION OF THE DRAWINGS

These and other features and advantages of the invention will be further understood from the following detailed description of embodiments of the invention with reference to the accompanying drawings.

FIG. 1 is a schematic three-dimensional view of an apparatus according to an embodiment of the invention.

FIG. 1A is an enlargement of a portion of FIG. 1.

FIG. 2 is a schematic three-dimensional view of an apparatus according to another embodiment of the invention.

FIG. 3 is a schematic three-dimensional view of an apparatus according to the invention for yet a further embodiment of the invention.

FIG. 4 is a schematic three-dimensional view of a storage unit with feed-in and discharge.

FIG. 5 is a schematic three-dimensional view of an apparatus according to still another embodiment of the invention.

FIG. 6 is a schematic three-dimensional view of an apparatus according to another embodiment of the invention.

FIG. 6A is an enlargement of a portion of FIG. 6.

FIG. 7 is a schematic three-dimensional view of a storage unit with feed-in and discharge according to yet another embodiment of the invention.

### DETAILED DESCRIPTION

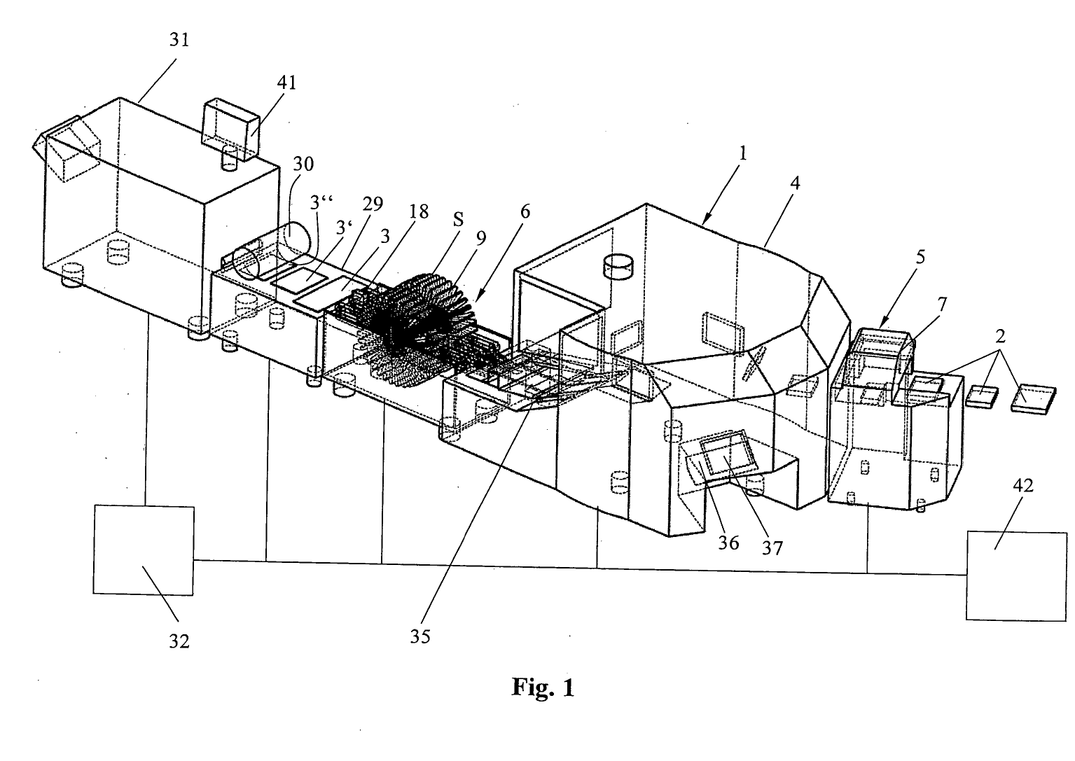

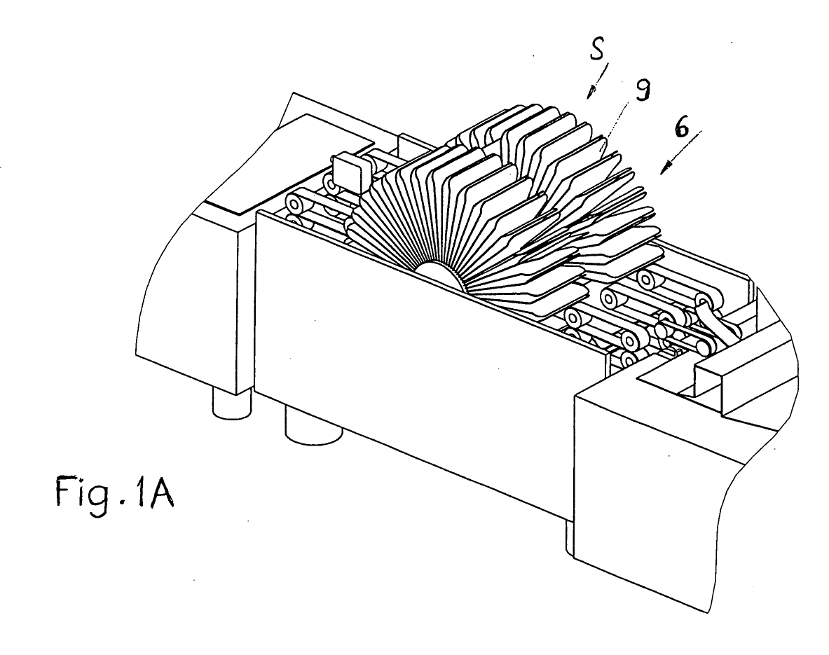

Referring to the drawings, there is shown in FIG. 1 an apparatus 1 provided with a processing device 4, in particular embodied as a perfect binder, for example as disclosed in European Patent Application 1 199 187 A. The perfect binder can be embodied as a revolving table, but can also have a different design, wherein a linear arrangement of the stations is also conceivable. Respectively one book block 2 is provided with a cover 3 in processing device 4. The book blocks 2 are produced inside a book block printer 42, which is only indicated schematically herein. This book block printer 42 is preferably a digital printer, which allows a sequential production of the printed products 2. Successively following book blocks 2 can differ with respect to content as well as format, wherein small editions, very small editions, as well as single-copy editions of these book blocks 2 can also be produced in the book block printer 42.

The book blocks 2 are supplied at a first feed-in station 5 to the processing device 4 by using a standard conveying arrangement that is not shown herein and is provided, for example, with conveying belts. The first feed-in station 5 comprises a detection device 7 for the individual identification of the book blocks 2. For this embodiment, the detection device 7 comprises a known reading device provided with a suitable sensor. The identification characteristic can take the form of a barcode, not shown herein, which is affixed to the book blocks 2. A different characteristic can also be used in place of a barcode, wherein this identification characteristic can furthermore be invisible to the naked eye. The identified characteristic on a book block is supplied to a control unit 32, which is connected to the book block printer 42 that is connected to the first feed-in station 5 and the processing device 4. As a result, the control unit 32 is always informed of the type of book block 2 that is supplied to the processing device 4.

The covers 3, which are respectively combined with a book block 2, are supplied to a second feed-in station 6 of the processing device 4. This second feed-in station 6 comprises a storage unit S which in FIG. 1 comprises a fan wheel 9, shown with further detail in FIG. 1A. Fan wheel 9 is positioned on a frame 8 and rotates around a shaft 12. A drive, not shown herein, can be used to control the fan wheel 9 to rotate in both rotational directions, as indicated with the double arrow 13. The rotation is controlled by the control unit 32, which is also connected to storage unit S. The fan wheel 9 is provided with a plurality of compartments, for example thirty compartments 10, which are respectively provided with two flaps 11. The flaps 11 are movable, so that the compartments 10 can be opened and closed for accommodating a cover 3. It is advantageous if the covers 3 are inserted in the radial direction into the compartments 10, wherein an axial insertion is possible as well. The compartments 10 can also be replaced by different suitable devices, for example grippers or the like. Mechanisms for holding and/or positioning the covers 3 can be provided inside the compartments 10.

The feed-in station 6 has an intake conveyor 14 and a discharge conveyor 15, wherein both conveyors 14 and 15 are also controlled by the control unit 32. The intake conveyor 14 comprises belts 16 for picking up the covers 3 and supplying these separately and precisely positioned to one of the compartments 10. The requested covers 3 are removed individually from the separate compartments 10 with the aid of the discharge conveyor 15 that is provided with the conveying belts 17, and are supplied in the direction of arrow 20 to the processing device 4. The control unit 32 also controls the discharge conveyor 15, wherein the arrow 19 indicates the direction in which the covers 3 are supplied to the storage unit S.

A detection device 18 is provided in the area upstream of the feed-in location and preferably in the region of the intake conveyor 14 for identifying the incoming covers 3. For example, the covers are identified in a manner known per se with a reading device that is not shown in further detail herein. For the identification, the individual covers 3 are provided with an identification characteristic such as a barcode or a different suitable identification characteristic that is either visible or not visible to the naked eye. The detection device 18 is connected to the control unit 32, which is consequently always informed which cover 3 must be supplied to the storage unit S and to which compartment 10 the cover 3 must be supplied. The control unit 32 therefore always has the information of whether or not the storage unit S is occupied. The control unit 32 is always informed whether the compartments are occupied and which of the compartments 10 is actually occupied.

FIG. 1 shows, for example, only one fan wheel 9 for the second feed-in station 6. However, embodiments are conceivable where the second feed-in station 6 is provided with more than one fan wheel 9, wherein these can be arranged in series or parallel to each other.

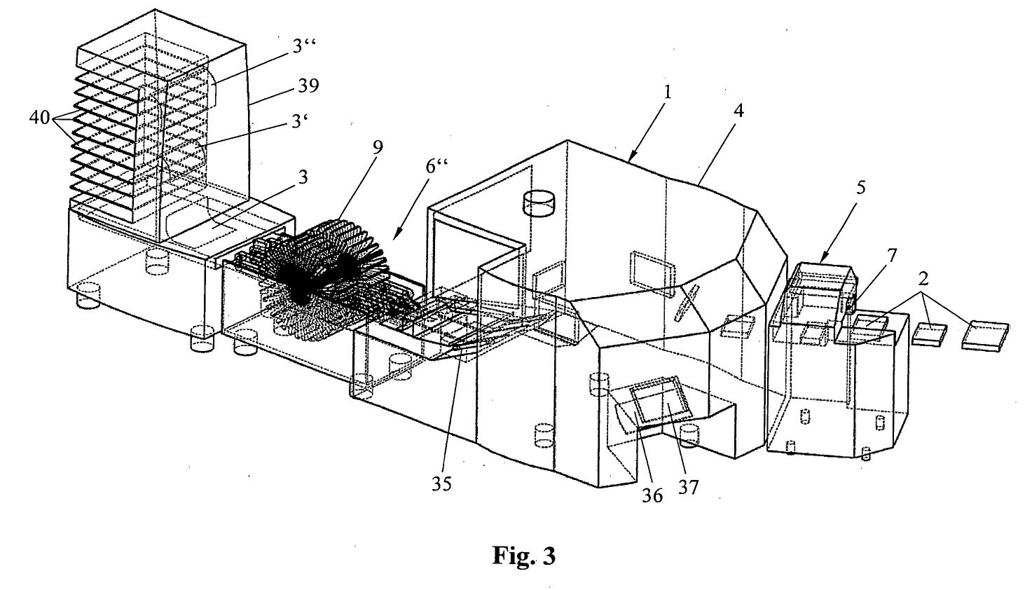

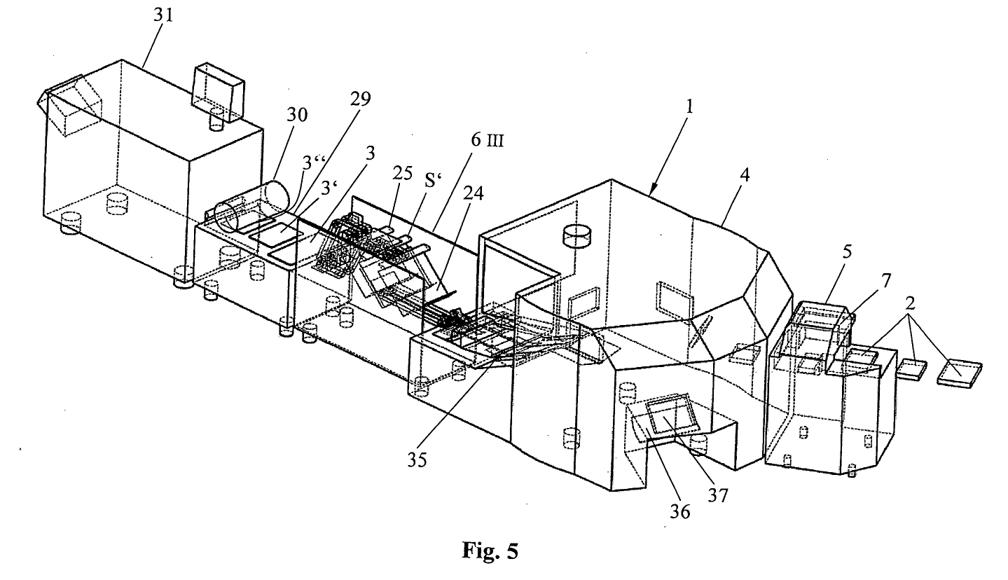

As shown in the embodiments of FIGS. 1 and 5, a processing station, for example a laminating device 29 with a laminating roller 30, may be arranged upstream of the second feed-in station 6. The covers 3 can be laminated in the laminating device 29. Three different covers 3, 3′, and 3″ are shown in FIGS. 1 and 5, wherein the covers 3, 3′, and 3″ can vary with respect to format, printing, and otherwise. The laminating device 29 can furthermore be replaced with a different suitable station for processing the covers 3, wherein an embodiment without a laminating device 29 is also conceivable, so that the covers 3 are supplied without processing to the storage unit S, as shown for example in FIG. 3.

The covers 3 are printed in a digital printer 31. The printer 31 is connected to the control unit 32, wherein the control unit 32 can also function as control unit for the printer 31. Alternatively, the printer 31 can comprise an attachment 41 that is provided with display means and input means, which are not shown herein. The attachment 41 is therefore used to input orders and to monitor the progress. The printer 31 is preferably a digital printer which allows a sequential production of the covers 3, 3′ and 3″. In principle, however, the printer 31 can also be a conventional printer, such as an offset printer.

The covers 3, 3′ and 3″ that are printed inside the printer 31 are assigned in the correct position to the compartments 10 of the storage unit S. As previously mentioned, the control unit 32 which administers the storage unit S is therefore informed continuously which cover 3, 3′ and/or 3″ is located in which compartment 10. The control unit 32 ensures that all storage locations within the storage unit S are used with the highest degree of efficiency. The control unit 32 selects which cover 3, 3′ and/or 3″, not previously assigned to a suitable book block 2, must be removed from the storage unit S or must be returned to it at a later date. If a book block 2 is detected by the detection device 7 during the production, then the control unit 32 requests the associated cover 3, 3′, and/or 3″ and the second feed-in station 6 supplies this cover to the processing device 4. The respective book block 2 is subsequently combined with the intended cover 3, 3′ and/or 3″ inside the processing device 4, wherein a printing order for one or several book blocks 2 can also be triggered based on the detection of a cover 3, 3′ and/or 3″.

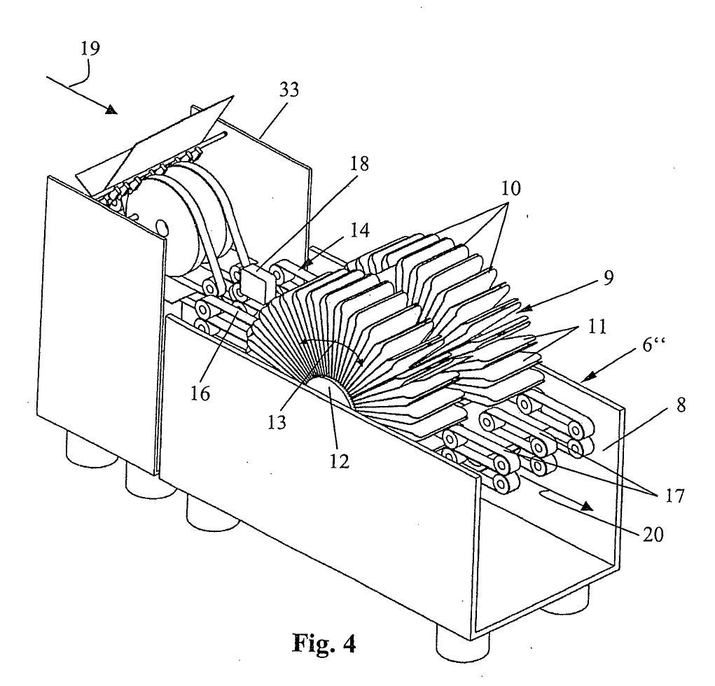

The storage unit S comprises a specific number, for example thirty, storage places. To start up production for an edition, e.g. numbering thirty books, the storage unit S is filled with the corresponding number of covers 3. If a book block 2 is removed upstream of the detection device 7, thereby resulting in a change in the sequence for the book block, this book block 2 can be inserted again at a later point in time. A change of this type in the sequence can also occur when using a buffer section. Depending on the configuration of the control, a cover 3 waiting to be supplied during the passage of thirty stations of the processing device 4 can be removed to make room in the storage unit S for a different cover that is next in sequence. The cover is removed at a discharge station 36, which can also be used for discharging the printed products 37 provided with a cover 3. For signal transmission, the control unit 32 is furthermore connected to the storage unit S and the laminating device 29, as shown in FIG. 1. Empty compartments 10 (FIG. 4), 24 (FIG. 5) are preferably refilled immediately after they are emptied, wherein the new cover does not have to be identical to the previous cover.

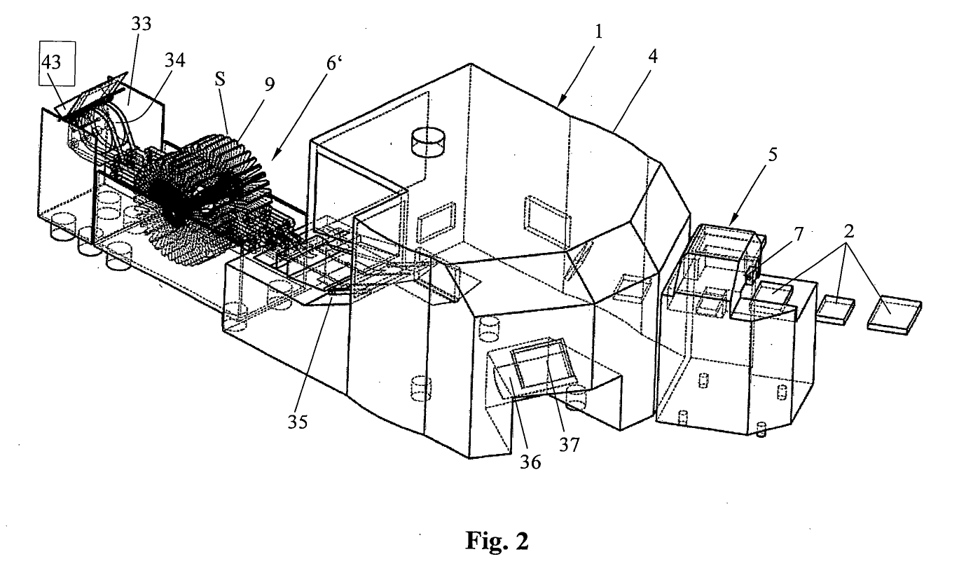

The apparatus 1 shown in FIG. 2 differs from the apparatus shown in FIG. 1 only in the design of the second feed-in station 6′. This station is provided with a feeder 33, for example comprising a standard withdrawing drum 34 for withdrawing the covers 3 from a stacking device 43 and supplying these to the storage unit S. The covers 3 in this case may also be identified with the aid of the detection device 18 (see FIGS. 1 and 4). A high number of covers 3 can be stacked in the stacking device 43, thereby making possible a high capacity and output. As detailed in the above, the covers 3 are preferably printed inside a digital printer, wherein this process is advantageously also controlled as explained in the above with the aid of FIG. 1.

FIG. 3 shows a different embodiment of an apparatus 1 with a second feed-in station 6″. With this second feed-in station 6″ the covers 3 are stored inside a multi-sheet feeder 39. This multi-sheet feeder 39 comprises a plurality of compartments 40, arranged essentially one above the other in the shape of a tower, in which preferably several covers 3, 3′, and/or 3″ are deposited. The covers 3, 3′, and/or 3″ are withdrawn from these compartments 40 in a manner known per se, for example with the aid of suction devices or similar devices that are not shown herein. The multi-sheet feeder 39 also permits a high capacity and output, thereby ensuring at all times that the required covers 3, 3′ and/or 3″ are available and/or that these can be supplied to the storage unit S.

FIG. 5 depicts a different embodiment of an apparatus 1 with a second feed-in station 6′″, which comprises a storage unit S′ provided with several compartments 24 that are arranged one behind the other in a row. These compartments 24 are positioned at an angle relative to the transporting direction, as can be seen. A diverter 25 is arranged above each compartment 24, wherein this diverter can occupy two positions that are not shown herein. In the one position, a cover 3, 3′ and/or 3″ is diverted into the respective compartment 24 while in the other position, the cover 3, 3′ and/or 3″ is conveyed further.

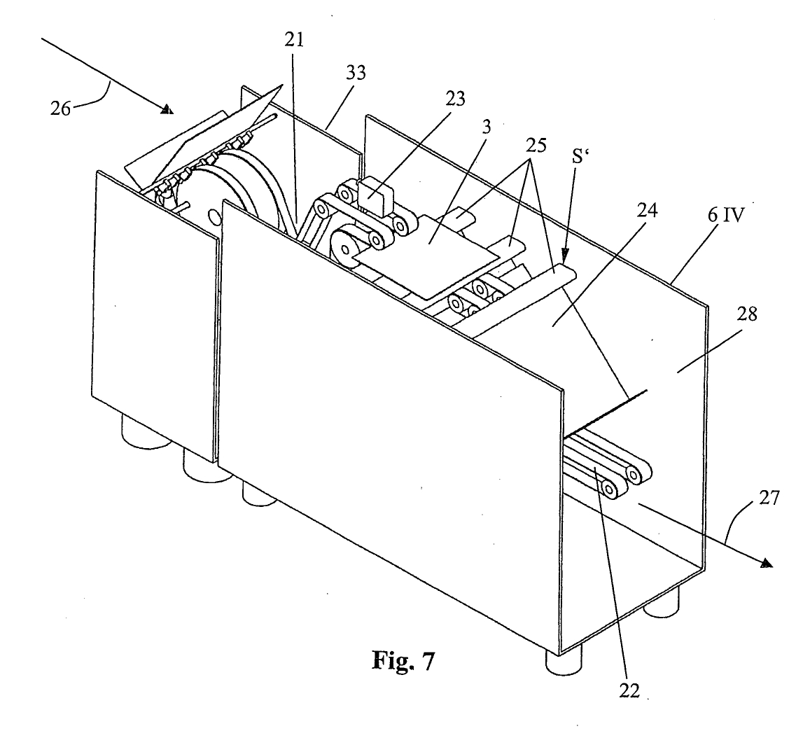

FIG. 7 shows that the covers 3, 3′, and/or 3″ are supplied to the compartments 24 with the aid of an upward moving intake conveyor 21. A detection device 23 for identifying the covers 3, 3′ and/or 3″ is arranged in an upper region and can be embodied and function as explained in the above. The direction for feeding the covers 3, 3′ and/or 3″ into the intake conveyor 21 is indicated with the arrow 26 in FIG. 7. The covers 3, 3′ and/or 3″ are conveyed to a ramp 35 of the processing device 4 with the aid of a discharge conveyor 22, which conveys the corresponding covers 3, 3′ and/or 3″ in horizontal direction, as shown with arrow 27. The storage unit S′ has a frame 28 for positioning the compartments 24 and the intake conveyor 21, as well as the discharge conveyor 22. The storage unit S′ for this embodiment is also controlled by the control unit 32. The same is true for the diverters 25 as well as the intake conveyor 21 and the discharge conveyor 22. The covers 3, 3′ and/or 3″ inside the storage unit S′ are basically controlled as explained in the above for the storage unit S. As before, the control unit 32 is again always informed as to which cover 3, 3′ and/or 3″ is present in a respective compartment 24.

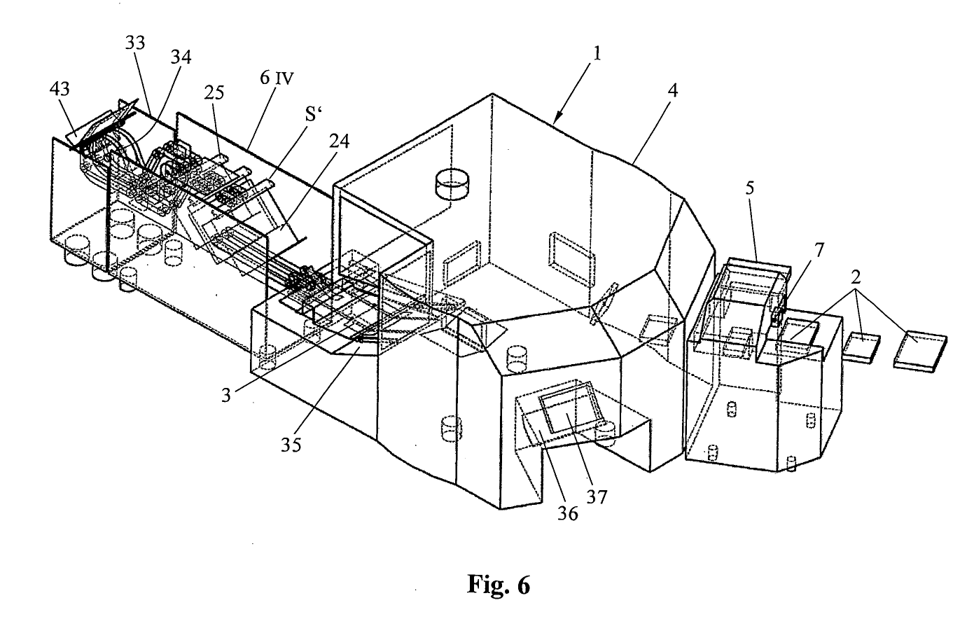

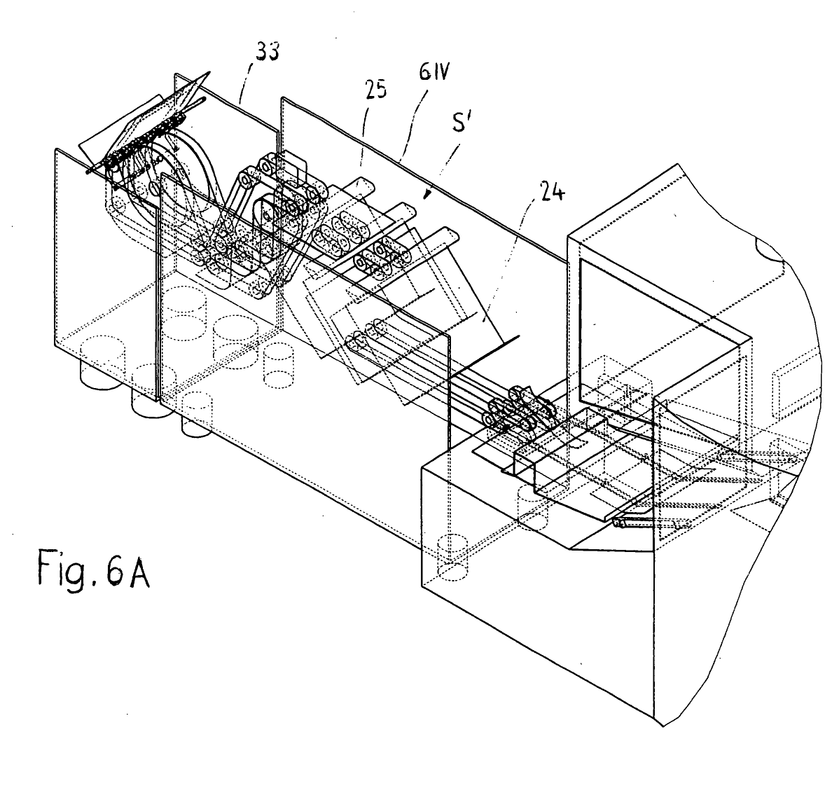

A different embodiment of the apparatus 1, shown in FIG. 6, is provided with a second feed-in station 6IV. FIG. 6A is an enlarged representation of a portion of FIG. 6 In this embodiment, a feeder 33 is located upstream of the storage unit S′, as previously explained with the aid of FIG. 2. The feeder 33 is again used to withdraw covers 3, 3′, and/or 3″ from the stacking device 43 and to supply these covers to the storage unit S′. For this embodiment, the multi-sheet feeder 39 can optionally be provided in place of the feeder 33, wherein a laminating device 29 or a different processing device can be arranged between the feeder 33 and the feed-in station 6IV.

According to a further embodiment of the invention, there is provided a virtually controlled feeding of the covers and/or book blocks to the processing device, whereby the supplied products are detected and stored in a computer and supplied computer-controlled to the further processing operation. The processing occurs in a predetermined machine cycle, resulting in a product tracking which makes it possible to find the products along the processing path.

It will be understood that the above description of the present invention is susceptible to various modifications, changes and adaptations, and that the same are intended to be comprehended within the meaning and range of equivalents of the appended claims.

What is claimed is:

1. A method for producing printed products, comprising:
supplying book blocks and covers along respectively separate conveying paths to a processing device;
feeding the covers with a controlled movement to a specific compartment of a storage unit having a plurality of compartments arranged along the conveying path of the covers to the processing device, wherein each compartment is supplied with only one cover; and
combining respectively one book block and a spine of one cover in the processing device.

2. The method according to claim 1, including virtually controlling the supplying of the covers and/or the book blocks to the processing device.

3. The method according to claim 1, including identifying the covers upstream of the storage unit with a detection device.

4. The method according to the claim 1, wherein the identifying step includes providing the covers respectively with an identification characteristic.

5. The method according to claim 1, wherein the conveyor for the covers includes an input conveyor and a discharge conveyor, and further including moving the compartments between the intake conveyor and the discharge conveyor; and moving the compartment with a controlled movement from the discharge conveyor to the intake conveyor to refill an empty compartment.

6. The method according to claim 5, including rotating the compartments around a joint shaft.

7. The method according to claim 4, including using the identification characteristic on a cover to trigger a command to a printer to produce a book block.

8. An apparatus for producing printed products comprising:
a processing device in which respectively one cover is attached to a spine of a book block;
a first feed-in station from which the book blocks are supplied to the processing device;
a second feed-in station from which the covers are supplied to the processing station;
a storage unit having a plurality of compartments to accommodate respectively one cover;
an intake conveyor arranged upstream of the storage unit to feed one cover from the second feed-in station to respectively one compartment of the storage device; and
a discharge conveyor arranged downstream of the storage unit to convey the covers from the storage unit to the processing device.

9. The apparatus according to claim 8, further including a detection device to arranged upstream of the storage unit to identify the covers and to read out an identification characteristic affixed to a cover so that a corresponding signal from a control unit can be transmitted.

10. The apparatus according to claim 8, wherein at least one of the intake conveyor or the discharge conveyor comprises a telescopic conveyor.

11. The apparatus according to claim 8, wherein the storage unit comprises a fan wheel.

12. The apparatus according to claim 11, wherein the compartments are moveable, respectively, between the intake conveyor and the discharge conveyor.

13. The apparatus according to claim 8, wherein the individual compartments include a mechanism to hold a cover.

14. The apparatus according to claim 8, wherein the compartments are essentially arranged linearly, one behind the other, side-by-side, or one above the other.

15. The apparatus according to claim 8, further including a printer to print the covers and to supply the covers to the storage unit.

16. The apparatus according to claim 8, further including at least one feeder to supply the covers to the storage unit.

17. The apparatus according to claim 16, wherein the feeder is a multi-sheet feeder.

18. The apparatus according to claim 8, further including a control unit to trigger an order for printing one or several book blocks based on detection of a cover.
